(19) United States
(12) Patent Application Publication
(10) Pub. No.: US 2009/0298026 A1
(43) Pub. Date: Dec. 3, 2009

(54) SYSTEMS AND METHODS FOR NEUROPSYCHOLOGICAL TESTING

(75) Inventors: Phil Cohen, Bainbridge Island, WA (US); Paulo Barthelmess, Renton, WA (US)

Correspondence Address: BLACK LOWE & GRAHAM, PLLC, 701 FIFTH AVENUE, SUITE 4800, SEATTLE, WA, 98104, US

(73) Assignee: Adapx, Inc., Seattle, WA (US)

(21) Appl. No.: 12/477,032

(22) Filed: Jun. 2, 2009

Related U.S. Application Data
(60) Provisional application No. 61/058,161, filed on Jun. 2, 2008.
(60) Provisional application No. 61/115,836, filed on Nov. 18, 2008.

(51) Int. Cl. G09B 19/00

(52) U.S. Cl. 434/236

(57) ABSTRACT

A system for administering a neuropsychological test using a digital pen and paper system includes various recognition modules for interpreting ink markings applied by the digital pen to a digital testing document. The recognition modules may interpret handwriting, symbols, sketches, etc. In addition, the system may include one or more error correction modules for detecting and correcting test-taker-driven errors or recognition-driven errors. The error correction module may operate in real time to communicate with the test taker, may be employed before a normalizing and scoring process or some combination of both. In one embodiment, normalized data or automatically determined test scores obtained after appropriate correction may be transmitted to a patient record or file to await a review and possible diagnosis by a mental health provider.

### PRIORITY CLAIM

This application claims priority to U.S. Provisional Patent Application Nos. 61/058,161 (filed on Jun. 2, 2008) and 61/115,836 (filed on Nov. 18, 2008), wherein the subject matter of each is incorporated herein by reference in its entirety.

### FIELD OF THE INVENTION

This invention relates generally to systems and methods for neuropsychological testing using a digital pen and paper system, and more specifically to systems and methods for handling information applied to a digital testing document with a digital pen during and after a neuropsychological test.

### BACKGROUND OF THE INVENTION

Mental health professionals often need to evaluate the cognitive abilities of a person, such as memory, organization ability and intellectual capacity, or to identify cognitive skills that have been impaired, for example, by head injuries, neurological disorders, learning disabilities or psychiatric illnesses. To this end, various psychological tests have been developed such as those described in U.S. Pat. Nos. 6,629,846 and 7,267,440. It has been further suggested that digital pen and paper technology may be used to administer at least some types of psychological tests. See “Use of a Digital Pen to Administer a Psychomotor Test” by Tiplady et al., The University of Edinburgh, Journal of Psychopharmacology 17 (Suppl. 3): A71 (2004).

In addition to the psychological tests, other tests have been suggested to test impaired drivers using digital pen and paper technology. See “Anoto Digital Pen and Paper Impairment Device” by Davies et al., The University of Birmingham (2004); http://www.icadts.org/t2004/pdfs/113.pdf; and see An Investigation of Measurement into Driver Impairment at the Roadside Using a Logitech Digital Pen” by Davies et al., School of Computer Science, The University of Birmingham (2004); http://www.icadts.org/T2004/pdfs/O110.pdf.

Independent from the psychological and impairment tests discussed above, conventional digital pen and paper systems include at least a digital pen device and may include a conventional or digital writing surface. The digital pen device knows its location in real time on the writing surface. Some digital writing surfaces include a visible or non-visible digital pattern. One type of digital writing surface takes the form of digital paper made by the Anoto Group AB having an ANOTO® digital pattern. Various types of conventional digital pen devices include, but are not limited to, the MAXELL® digital pen, the NOKIA® digital pen, the LEAPFROG FLYFUSION® digital pen, the ANOTO® digital pen, the LOGITECH® digital pen, the LIVESCRIBE® digital pen, and the ADAPX® digital pen. Besides knowledge of placement location, some digital paper systems also maintain records of information like pressure or time as well as various “state” values such as color or width.

### BRIEF DESCRIPTION OF THE DRAWINGS

Preferred and alternative examples of the present invention are described in detail below with reference to the following drawings:

FIG. 1 is a block diagram showing a computer, various computer peripherals, and various communication means for the computer according to an embodiment of the invention;

FIG. 2 is a block diagram showing a system for administering a neuropsychological test using a digital pen and paper system in communication with modules for interpreting ink markings made to a testing document according to an embodiment of the present invention;

FIG. 3 is a block diagram showing a system for administering a neuropsychological test using a digital pen and paper system in communication with an error correction module for correcting either patient-driven or recognition-driven errors applied to a testing document according to an embodiment of the present invention; and

FIG. 4 is method for administering a neuropsychological test using a digital pen and paper system while correcting identified errors, if any, found when interpreting ink markings applied to a testing document according to an embodiment of the present invention.

### DETAILED DESCRIPTION OF THE PREFERRED EMBODIMENT

In the following description, certain specific details are set forth in order to provide a thorough understanding of various embodiments of the invention. However, one skilled in the art will understand that the invention may be practiced without these details or with various combinations of these details. In other instances, well-known systems and methods associated with, but not necessarily limited to, digital documents, digital paper, digital pen devices, neuropsychological and/or cognitive related tests and scoring of same, and methods for recognizing, interpreting and processing ink markings applied to a document with a digital pen device may not be shown or described in detail to avoid unnecessarily obscuring descriptions of the embodiments of the invention.

At least one embodiment relates generally to a system for administering a neuropsychological test using a digital pen and paper system in communication with modules for interpreting ink markings made to a testing document. In real time or after ink markings are received and interpreted by the system, identified errors that are either patient-driven or recognition-driven may be corrected before the test results are processed for scoring. The patient-driven errors may occur when a test taker makes an unintended or undesired mark with the digital pen on the testing document; whereas recognition-driven errors may occur when handwritten alphanumeric, graphic, or other types of ink markings are processed by one or more recognition software modules, which may take the form of a handwriting recognition module, a symbol recognition module, using a constrained subgraph matching module, or some combination of the above. In addition, the system may include a normalization module for analyzing the interpreted ink markings and a scoring module for determining a score based on the normalized test results after appropriate error correction has been applied. In one embodiment, the normalized data may be transmitted to a patient record or simply a score may be transmitted to await a review and possible diagnosis by a mental health provider.

In one aspect of the present invention, a method for administering a neuropsychological test includes the steps of (1) recording ink markings applied to a digital testing document using a digital pen; (2) interpreting the ink markings received from the digital pen; (3) selectively evaluating the interpreted data for purposes of correcting one or more recognition-based errors made during interpretation; and (4) if correction is needed, correcting the one or more recognition-based errors.

In another aspect of the present invention, a method for administering a neuropsychological test includes the steps of (1) recording ink markings applied to a digital testing document using a digital pen; (2) interpreting the ink markings received from the digital pen; (3) selectively evaluating the interpreted data in real time or subsequent to the test-taking, for purposes of correcting one or more errors made during interpretation; and (4) if correction is needed, correcting the one or more errors.

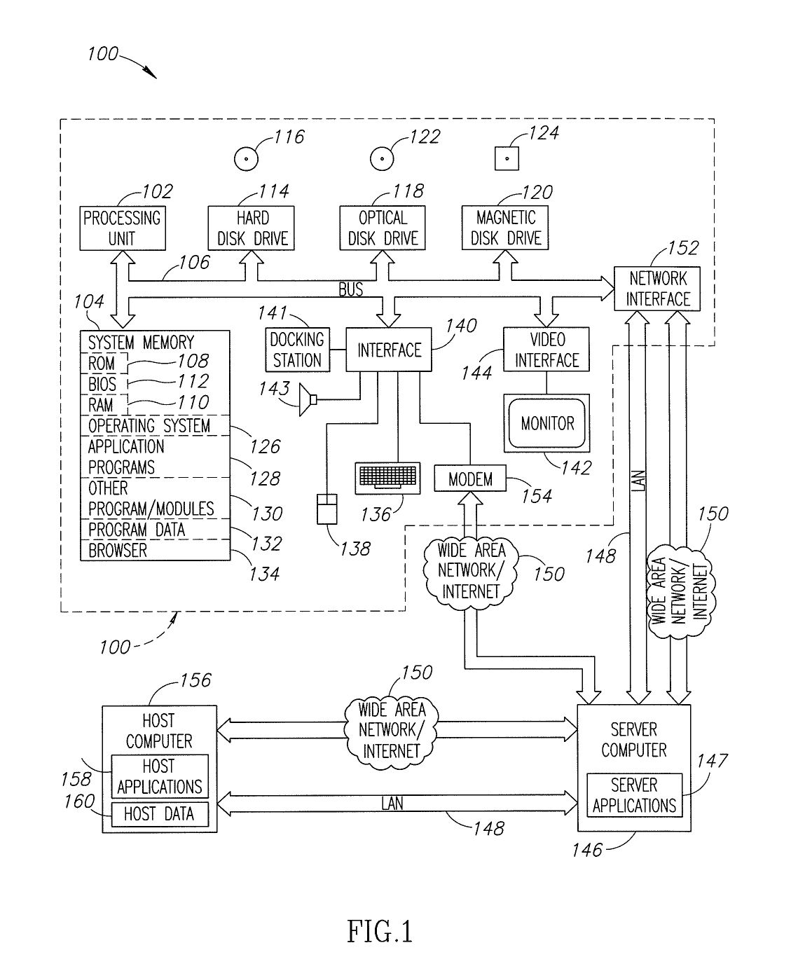

FIG. 1 in cooperation with the following provides a general description of a computing environment that may be used to implement various aspects of a system for administering a neuropsychological test. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, digital pens, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The application programs 128, program or modules 130, and program data 132 may include information, instructions and parameters for creating, manipulating, uploading and processing a digital palette and document system. The system memory 104 also includes a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 100 as a personal computer, in other embodiments, the computer is some other computer-related device such as a personal data assistant (PDA), a cell phone, digital pen, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. Another interface device that may be coupled to the bus 106 is a digital pen docking station 141 configured to receive a digital pen for the purpose of data transmission, charging, etc. A monitor 142 or other display device is coupled to the bus 106 via a video interface 144, such as a video adapter. A speaker or other audio output device 143 may communicate with the interface 140 for providing information to a user. The computer 100 can include other output devices, such as printers, additional speakers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

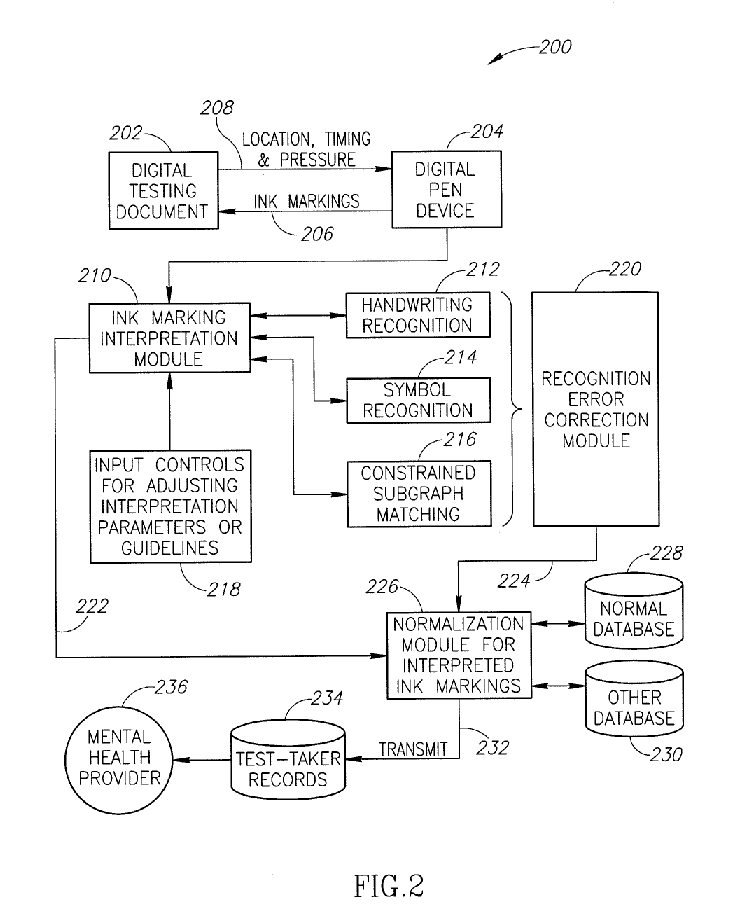

FIG. 2 shows a neuropsychological testing system 200 having a digital testing document 202 that receives one or more ink markings from a digital pen device 204. The questions, tasks or other activities required by a neuropsychological test may be printed or otherwise applied to either a visible or a non-visible digital pattern, thus making the testing document into the digital testing document 202. In one embodiment, the digital pattern may take the form of an ANOTO® digital pattern printed as a watermark. The digital pen device 204 may take the form of a digital pen with an ink cartridge so a test taker can apply ink markings 206 to the digital testing document 202. The digital pen device 204 may take the form of a digital pen used to mark on, select, indicate, or otherwise interact with the digital testing document 202. During application of such ink markings 206, the digital pen device 204 may detect, record and/or store location, timing, and/or pressure data 208 associated with an interaction of the digital pen device 204 with the digital testing document 202. For purposes of the description herein, the location, timing and/or pressure data 208 is hereinafter referred to as ink marking data or ink markings. The digital pen device 204, in addition to the above functions, may transmit the ink marking data 208 through either a direct or wireless data connection in real time or during a later selected time. By way of example, the digital pen device 204 may be docked in the digital pen docking station 141 (FIG. 1) for the ink marking data 208 to be transmitted or uploaded to the computer 100 (FIG. 1). In a preferred embodiment, the digital pen device 204 communicates with the computer 100 (FIG. 1) through a Bluetooth® or other wireless protocol so the ink marking data 208 may be received and processed in real time by the computer 100. In alternative embodiment, the ink marking data 208 may be received and processed by a processor located within the digital pen device 204 in real time.

An ink marking interpretation module 210 interprets or otherwise performs a recognition analysis of the ink marking data 208 received from the digital pen device 204. The ink marking interpretation module 210 may include, but is not limited to, a handwriting recognition module 212, a symbol recognition module 214, a constrained subgraph matching module 216, or other types of interpretation or recognition modules. In one embodiment, the ink marking interpretation module 210 communicates with input controls 218 that can be used to selectively adjust one or more interpretation or recognition parameters, guidelines or commands used by the ink marking interpretation module 210. In one embodiment, the input controls 218 include a graphical user interface (GUI) with drop down lists and sliders to enable the setting of parameters, guidelines or commands. These selective adjustments may be generated and incorporated into the ink marking interpretation module 210 in real time as a test taker applies ink markings 206 to the digital testing document 202. In another embodiment, the selective adjustments may be generated and incorporated before, after or contemporaneously with testing.

The system 200 further includes a recognition error correction module 220 that receives information from the ink marking interpretation module 210 for correcting recognition-driven errors. The recognition error correction module 220 may test additional points or features of handwritten text, sketched symbols or other types of ink markings if an initial or first-pass recognition is indeterminate or flagged for further analysis.

The interpreted data 222, and if necessary corrected data 224 may be submitted to a normalization module 226 that may communicate with a normalization database 228 or other databases 230 for normalizing and possibly scoring the data 222, 224. The normalization module 226 operates to normalize the data 222, 224 using predetermined testing guidelines or instructions for a particular test. Normalized data 232 may then be transmitted to a patient or test-taker record 234 directly, wirelessly, remotely, securely or by other means. A mental health provider 236 may access the patient record 234 to review the normalized data 232 and possibly provide a diagnosis. Additionally or alternatively, the mental health provider 236 may manually score the normalized data 232 and then compare the manual score to an automated score derived by the normalization module 226.

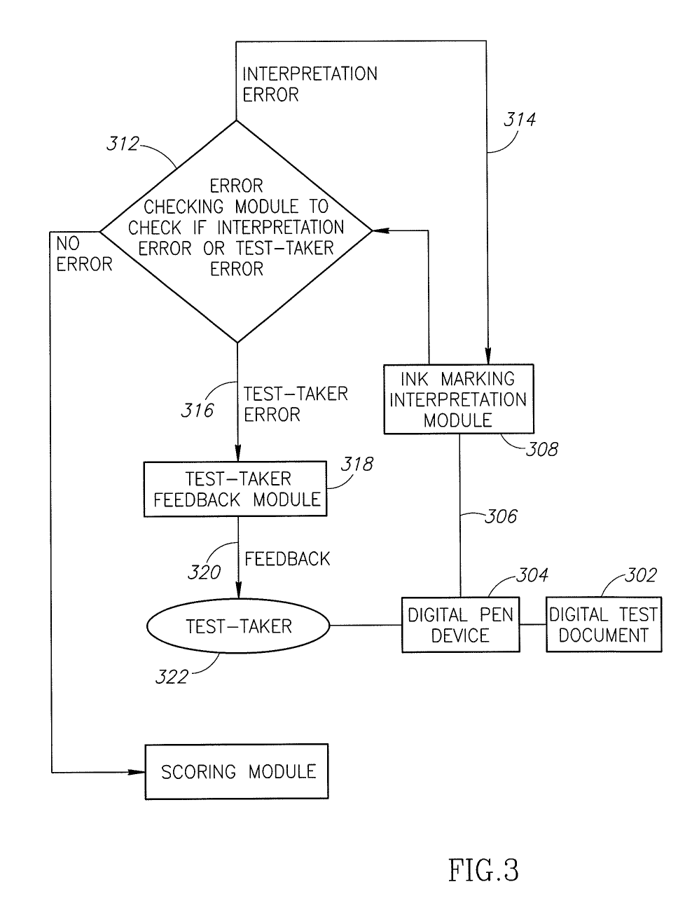

FIG. 3 shows a neuropsychological testing system 300 for checking errors made by a test taker in real time during testing. The system 300 includes a digital testing document 302 and a digital pen device 304 that provides ink markings 306 to an ink marking interpretation module 308. Interpreted ink markings 310 are submitted to an error checking module 312 to check if an interpretation/recognition or test-taker driven error has occurred during testing. An interpretation error 314 may be re-processed through the ink marking interpretation module 308 or processed as described in the aforementioned embodiment. In one embodiment, a test-taker driven error 316 is provided to a test-taker or patient feedback module 318 where an appropriate feedback command or instruction 320 may be determined. The feedback commend 320 is transmitted to the test taker 322 in real time through an audible, visual or haptic interface. Thus, in real time, the test taker 322 can correct the error and move forward with the testing.

In yet another embodiment, yet another neuropsychological testing system with automated scoring where a digital pen device records ink markings, including location, timing and pressure, and either stores this data for later transmission via docking with a computer or sends this data in real time to the computer. During a test, the system may access an appropriate plug-in or module to evaluate or otherwise process the ink markings, such as performing an appropriate recognition-based scoring. If the ink marking is determined to be textual and/or numeric handwriting, such as with a Symbol-Digit test, a handwriting recognizer may be used to interpret the ink markings. If the ink markings take the form of a symbol (e.g., ‘)’ or ‘>’ as in a Digit-Symbol test, the system utilizes a symbol recognizer to interpret the ink markings. The symbol recognizer may include parameters, commands or instructions based on neural networks, hidden-markov models, template matching, etc.

Because recognition may not be perfectly accurate based on a wide variety of internal and external variables, the recognition results may be presented to a medical health provider, or more specifically to a clinician/analyst, that may employ specific user interface tools selectively correct the recognition results. Some examples of specific user interface tools include, but are not limited to, drop-down lists of recognition results, ordered by recognition scores and/or confidence estimates, sliders that select a parameter value on a continuous scale, etc. Drop-down selections are useful for discrete recognition hypotheses, such as for the Symbol-Digit test, while sliders can be used for adjusting continuous parameters, as might be useful for adjusting “nearness” for the complex figure scoring methodologies used in the Rey-Osterreich, Taylor, or Clock tests, which are generally tests based on resemblance of a patient's drawings to a standard drawing. Such resemblance-based correction involves both recognition of a sub-figure (or ‘subgraph’) and constraint satisfaction. In the latter case, expressions such as ‘near’, ‘above’, ‘left-of’, ‘abuts’, etc. may be defined as geometric constraints, with ‘fuzzy’ values between 0 and 1 or between some other numeric range. Many metrics may be used to determine an appropriate correction, including, but not limited, to exponential, Gaussian, Haussdorf, and others. In one embodiment, the mental health provider interacts with input controls from a graphic user interface and does not need to type any values or apply any marks in any way.

The data, after correction, may be automatically entered into a database or spreadsheet program, such as an EXCEL® spreadsheet program by Microsoft. With the corrected values and timing information, the system applies the appropriate normalizing or scoring regime to that value set. For example, for the Symbol-Digit test, the normalizing or scoring involves determining the number of correctly written digits entered ninety seconds. For the Digit-Symbol test, the normalizing or scoring is similar, but the test taker generates writing symbols rather than numbers. For tests with multiple True/False checkboxes (such as the Minnesota Multi-phasic Personality Inventory) or checked selections (such as the NEUROPSYCHOLOGICAL IMPAIRMENT SCALE test), the normalizing or scoring assigns the appropriate value to the appropriate question (e.g., Question 26=True). The data can be sent to an appropriate interpretation and diagnosis routine or module, locally, or securely over a network, such as the Internet.

If the user has checked multiple boxes for the same question, the automated normalizing or scoring method may use the timing information from the digital ink to determine the latest box scored. Thus, the test taker does not need erase any ink markings, however for True/False or “check-the-box” type questions the test taker may correct one or more of their ink markings by touching an ‘Eraser’ icon printed on the digital testing document and then marking a line through the incorrect answer.

Test scoring involves both applying the test-specific methodology, as well as looking up the data values in a database of ‘norms’, which might indicate the mean and standard deviation (or other statistics) of those data values, applying transformations based on the test-taker's demographic data (e.g., age, gender, educational level, etc.) as appropriate for the specific test. Test scoring can involve recording the timing of the user's checking of boxes or answering of questions. For example, answers to questions on a personality inventory that take an abnormally long time to be answered might flag a person of interest. Scoring of the test may not, and often is not, equivalent to interpreting the test or providing a diagnosis.

In one embodiment, the test-taker may be corrected in real-time when an error is made during testing. By way of example, a test where the test-taker attempts to connect circles in numerical and/or alphabetical order may benefit from such real time error correction. Thus, the system may employ a real-time, ‘streaming’ approach, in which the ink markings recorded from the digital testing document are transmitted in real-time to the error checking module. The module would recognize when the ink markings have intersected with a circle such that if the test-taker has drawn the line to an incorrect circle then the module would generate feedback to the test-taker in real time. The feedback may take the form of an audible command using either text-to-speech or recorded speech technologies, a visual command provided over a display device, or a haptic signal provided through the digital pen device.

This real-time corrective method of test administration enables the test to be administered in a variety of environments more convenient for the test-taker, such as the test-taker's residence, and even when a test technician (psychometrician or clinician) is not available. The data from such a test may be scored automatically, and then sent electronically in a secure way to the mental health provider for review and/or diagnosis.

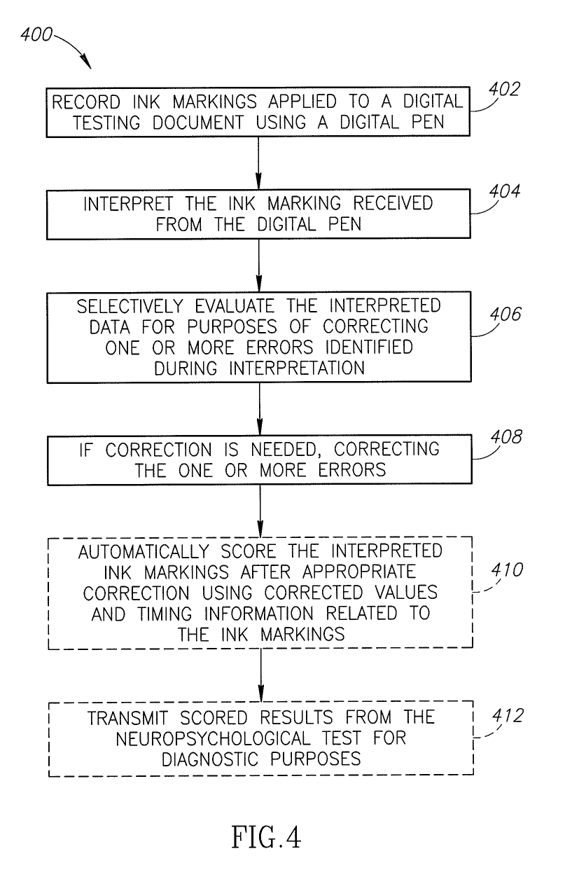

FIG. 4 shows a method 400 for administering a neuropsychological test using a digital testing document and a digital pen device. At step 402, the method includes recording ink markings applied to a digital testing document using a digital pen. At step 404, the method includes interpreting the ink markings received from the digital pen. At step 406, the method includes selectively evaluating the interpreted data for purposes of correcting one or more errors identified during interpretation. And, at step 408 and if correction is needed, correcting the one or more errors. In addition and at step 410, the test results may be automatically scored using interpreted ink markings after appropriate correction and/or after additional analysis using location and timing information associated with the ink markings. At step 412, the scored test results may be transmitted for review, diagnostic or other purposes.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method for administering a neuropsychological test, the method comprising:
recording ink markings applied to a digital testing document using a digital pen;
interpreting the ink markings received from the digital pen;
selectively evaluating the interpreted data for purposes of correcting one or more recognition-based errors made during interpretation; and
if correction is needed, correcting the one or more recognition-based errors.

2. The method of claim 1, further comprising recording information related to a timing of the ink markings for one or more marks made on the digital testing document using the digital pen.

3. The method of claim 1, further comprising automatically entering the interpreted data into a database program before automatically and selectively evaluating the interpreted data.

4. The method of claim 3, wherein automatically entering the interpreted data into the database includes automatically entering the interpreted data into a spreadsheet program.

5. The method of claim 1, wherein correcting the one or more recognition-based errors includes correcting interpretation errors from alphanumeric text applied by the digital pen to the digital testing document.

6. The method of claim 1, wherein correcting the one or more recognition-based errors includes correcting interpretation errors from graphical markings applied by the digital pen to the digital testing document.

7. The method of claim 6, wherein correcting interpretation errors from graphical markings includes correcting interpretation errors from non-alphanumeric symbols.

8. The method of claim 1, further comprising automatically scoring the interpreted ink markings after appropriate correction using location and timing information associated with the ink markings.

9. The method of claim 8, wherein automatically scoring includes determining whether the ink markings applied within a desired amount of time correspondingly match a number of predefined test answer markings.

10. The method of claim 8, wherein automatically scoring includes assigning a value corresponding to an answer marked on the digital testing document in response to a question.

11. The method of claim 8, wherein automatically scoring includes using the timing information obtained from the digital pen to determine an amount of elapsed time between selected ink markings applied to the digital testing document with the digital pen.

12. The method of claim 8, wherein automatically scoring includes looking up values applied to the interpreted data in a database of normalized values.

13. The method of claim 1, further comprising providing real time feedback to a user making the ink markings on the digital testing document with the digital pen.

14. The method of claim 13, wherein providing the real time feedback includes generating audible commands through a computing system.

15. The method of claim 13, wherein providing the real time feedback includes generating haptic responses through a computing system

16. The method of claim 13, wherein providing the real time feedback includes generating visual commands through a computing system.

17. The method of claim 13, wherein providing the real time feedback includes generating audible commands when the user makes an undesired ink marking on the digital testing document with the digital pen.

18. The method of claim 1, further comprising transmitting scored results from the neuropsychological test for diagnostic purposes.

19. The method of claim 18, wherein transmitting the scored results includes sending the scored results over a secure communication system.

20. A method for administering a neuropsychological test, the method comprising:
recording ink markings applied to a digital testing document using a digital pen;
interpreting the ink markings received from the digital pen;
selectively evaluating the interpreted data in real time for purposes of correcting one or more errors made during interpretation; and
if correction is needed, correcting the one or more errors.

21. The method of claim 20, wherein selectively evaluating the interpreted data for purposes of correcting one or more errors includes checking real time for ink marking related errors made by a test subject.

22. The method of claim 20, wherein selectively evaluating the interpreted data for purposes of correcting one or more errors includes determining recognition-based errors made during interpretation of the ink markings.

23. The method of claim 20, further comprising adjusting one or more interpretation parameters to obtain a different interpreted result of the ink markings.

24. The method of claim 20, further comprising normalizing the interpreted data.

25. The method of claim 24, wherein normalizing the interpreted data includes accessing one or more databases.
